(19) United States
(12) Patent Application Publication
(10) Pub. No.: US 2009/0120566 A1
(43) Pub. Date: May 14, 2009

(54) FORMING MEMBER FOR ANTIREFLECTION STRUCTURE, TRANSFER MATERIAL EMPLOYED IN THE SAME, OPTICAL APPARATUS EMPLOYING ANTIREFLECTION STRUCTURE, AND MANUFACTURING METHOD FOR THE SAME

(76) Inventors: Hiroaki Okayama, Osaka (JP); Yoshiharu Yamamoto, Osaka (JP); Motonobu Yoshikawa, Osaka (JP); Keiki Yoshitsugu, Hyogo (JP)

Correspondence Address: MCDERMOTT WILL & EMERY LLP, 600 13TH STREET, NW, WASHINGTON, DC, 20005-3096, US

(21) Appl. No.: 11/995,641

(22) PCT Filed: Jul. 11, 2006
(86) PCT No.: PCT/JP2006/313773

§ 371 Date: Jan. 14, 2008

(30) Foreign Application Priority Data
Jul. 14, 2005 (JP) 2005-205510

(51) Int. Cl. B29C 65/14

(52) U.S. Cl. 156/230

(57) ABSTRACT

A forming member for antireflection structure according to the present invention comprises a transfer material and a to-be-transferred material, wherein: the transfer material can be peeled off from the to-be-transferred material; the transfer material is constructed such that a structure having a reversal shape of an antireflection structure in which structural units are arranged in a shape of an array at a period smaller than a minimum wavelength of light whose reflection should be prevented and which has an aspect ratio of unity or greater is formed on a principal surface of a base substrate part having flexibility; the to-be-transferred material is a structure formed from a resin and having the same shape as the antireflection structure; and the transfer material and the to-be-transferred material are arranged such that the structure having the same shape as the antireflection structure fills up the structure having a reversal shape of the antireflection structure. Thus, even in the inside of an assembled optical apparatus, an antireflection structure can easily be formed at a predetermined position. Further, the optical characteristics of the optical apparatus itself is not affected.

### TECHNICAL FIELD

The present invention relates to a forming member for antireflection structure, a transfer material employed in the same, an optical apparatus employing an antireflection structure, and a manufacturing method for the same. In particular, the present invention relates to: a forming member for antireflection structure that allows an antireflection structure to be easily formed on a surface where reflection of light should be prevented in the inside of an optical apparatus; a transfer material employed in the same; an optical apparatus in which this antireflection structure is formed on a surface where reflection of light should be prevented; and a manufacturing method for the same.

### BACKGROUND ART

In optical elements and optical components employed in various applications, an antireflection function of preventing the reflection of light is required in many cases. For example, in digital cameras whose market size is increasing in recent years, high magnification zooming and high-resolution are desired together with further size reduction. Especially in compact cameras, a complicated structure is unavoidable for compact construction of a lens barrel. Further, compact construction is necessary also for various optical components.

In such compact cameras, when unnecessary light that is caused by reflection from a lens barrel and member components and does not participate in the imaging reaches the imaging surface, stray light occurs and causes an increase in the generation of flare, ghost and the like that have adverse influence on the image quality. Thus, in the lens barrel, in order that unnecessary light should not reach the imaging surface, steps or inclinations where reflection angles are taken into consideration are provided in the inside. Alternatively, surfaces are satin-finished. Nevertheless, such configurations are not sufficient for reducing the unnecessary light.

Further, in recent years, for the purpose of further suppression of reflection of unnecessary light, antireflection processing in which an antireflection film composed of a single layer film formed from a low refractive index layer, a multilayer film formed by laminating a low refractive index layer and a high refractive index layer, or the like is formed by vapor deposition, sputtering, painting or the like is employed, for example, on optical functional surfaces of optical components such as a lens barrel and an aperture diaphragm (e.g., Japanese Laid-Open Patent Publication No. 2001-127852).

The antireflection film described in Japanese Laid-Open Patent Publication No. 2001-127852 can be formed by a general method such as vapor deposition or sputtering, and hence has been used widely in the conventional art. Nevertheless, complicated processes are necessary in precisely controlling the optical thickness of the antireflection film. Thus, improvement is desired in productivity and cost. Further, such an antireflection film has wavelength dependence, and hence its antireflection effect is low in wavelengths other than a predetermined wavelength. Thus, it is remarkably difficult to obtain a satisfactory antireflection effect throughout the visible light range which is necessary in an imaging optical apparatus. Furthermore, the antireflection film has also a problem of angle dependence that the antireflection effect decreases with increasing incident angle of light. Thus, development of an antireflection processing method has been desired in which wavelength dependence and angle dependence are improved.

In such situations, in recent years, as a method of resolving the problem of wavelength dependence and incident angle dependence, attention is focused on a technique of forming a structure (referred to as an antireflection structure) in which structural units having the shapes of fine protrusions or recesses are arranged with a submicron period on the optical functional surface of an optical element, an optical component or the like.

When such an antireflection structure is formed on the optical functional surface of an optical element, an optical component or the like, the refractive index distribution of the optical functional surface becomes remarkably smooth. Thus, incident light having a wavelength greater than or equal to the period of arrangement of the structural units having the shapes of protrusions or recesses enters almost completely into the inside of the optical element, the optical component or the like. Thus, reflection of light is prevented on the optical functional surface. Further, when this antireflection structure is formed on an optical functional surface, the antireflection effect does not remarkably decrease even when the incident angle of incident light increases. As such, when an antireflection structure is formed on the optical functional surface of an optical element, an optical component or the like, the problems of wavelength dependence and incident angle dependence in the above-mentioned antireflection film are resolved.

An employable method for forming an antireflection structure on the surface of a component such as an optical element and an optical component is that in the case of a component that can be formed by injection molding, a member having a reversal shape of an antireflection structure is formed in a mold for forming a component and then a component and an antireflection structure are molded integrally. Another employable method is that a mold in which a member having a reversal shape of an antireflection structure is formed is pressed against the surface of a component so that an antireflection structure is formed. Yet another method is that in the case of a component composed of a resin material, an antireflection structure is formed directly in the component by X-ray lithography, electron beam lithography (referred to as EB lithography, hereinafter) or the like. Another proposed method is that an antireflection structure is formed on a surface of a substrate such as a tape or a sheet and then the antireflection structure is bonded onto a surface of the component via this substrate (e.g., Japanese Laid-Open Patent Publication No. 2001-264520).

### Patent Document 1: Japanese Laid-Open Patent Publication No. 2001-127852

### Patent Document 2: Japanese Laid-Open Patent Publication No. 2001-264520

### DISCLOSURE OF THE INVENTION

### Problems to be Solved by the Invention

Nevertheless, the method of integrally molding a component and an antireflection structure by using a mold has a problem that a manufacturing process for the mold is complicated. Another problem is that in the components such as an optical element and a flexible board held by a jig at the time of assembling of the optical apparatus, when an antireflection structure has been formed in advance on the surface of the component, the antireflection structure is damaged at the time of holding by the jig. Further, the method of forming an antireflection structure directly in a component by X-ray lithography, EB lithography or the like has a problem that the method is difficult to be applied to the surface of a component having a curved shape or a complicated shape.

Further, in the method described in Japanese Laid-Open Patent Publication No. 2001-264520, an antireflection structure is bonded to a component via a substrate. This causes in the component design the necessity of consideration of the thickness and the optical characteristics of the substrate in addition to those of the antireflection structure. Further, in a case that the component to be provided with an antireflection structure is formed from a transparent medium for utilizing transmitted light, when the antireflection structure is bonded via the substrate, the construction material or the optical characteristics of the substrate sometimes affects the performance itself of the components such as an optical element and an optical component. Another problem is that when the antireflection structure is to be bonded to a component via a substrate, serious carefulness is necessary at the time of assembling in order to avoid damage to the antireflection structure.

Thus, an object of the present invention is to provide a forming member for antireflection structure that allows an antireflection structure to be formed easily at an arbitrary predetermined position even in the inside of an assembled optical apparatus, in particular, in a part having a complicated structure or a part to be held at the time of handling, and that yet does not affect the optical characteristics of the optical apparatus itself. Another object of the present invention is to provide a transfer material that is employed in this forming member for antireflection structure and that can be used repeatedly and hence has satisfactory productivity.

Yet another object of the present invention is to provide: an optical apparatus which employs the above-mentioned antireflection structure and in which entering of light whose reflection should be prevented is satisfactorily suppressed so that stray light does not occur and hence ghost and flare are reduced; and a manufacturing method for the same.

### Solution to the Problems

One of the above-mentioned objects is achieved by the following forming member for antireflection structure. That is, the present invention relates to

a forming member for antireflection structure serving as a member bonded at a predetermined position so as to form an antireflection structure, comprising

a transfer material and a to-be-transferred material, wherein:

the transfer material can be peeled off from the to-be-transferred material;

the transfer material is constructed such that a structure having a reversal shape of an antireflection structure in which structural units are arranged in a shape of an array at a period smaller than a minimum wavelength of light whose reflection should be prevented and which has an aspect ratio of unity or greater is formed on a principal surface of a base substrate part having flexibility;

the to-be-transferred material is a structure formed from a resin and having the same shape as the antireflection structure; and

the transfer material and the to-be-transferred material are arranged such that the structure having the same shape as the antireflection structure fills up the structure having a reversal shape of the antireflection structure.

Further, one of the above-mentioned objects is achieved by the following transfer material. That is, the present invention relates to

a transfer material employed in the above-mentioned forming member for antireflection structure.

Further, one of the above-mentioned objects is achieved by the following optical apparatus. That is, the present invention relates to

an optical apparatus, wherein:

an antireflection structure is provided on at least one of surfaces, in the inside, where reflection of light should be prevented; and

the antireflection structure is formed from the above-mentioned forming member for antireflection structure.

Furthermore, one of the above-mentioned objects is achieved by the following manufacturing method for optical apparatus. That is, the present invention relates to

a manufacturing method for optical apparatus in which an antireflection structure is provided on at least one of surfaces, at predetermined positions in the inside, where reflection of light should be prevented, the manufacturing method comprising:

(1) a step of forming, on a principal surface of a base substrate part having flexibility, a structure having a reversal shape of an antireflection structure in which structural units are arranged in a shape of an array at a period smaller than a minimum wavelength of light whose reflection should be prevented and which has an aspect ratio of unity or greater, and thereby producing a transfer material;

(2) a step of forming from a resin a to-be-transferred material serving as a structure having the same shape as the antireflection structure;

(3) a step of arranging the transfer material and the to-be-transferred material such that the structure having the same shape as the antireflection structure fills up the structure having a reversal shape of the antireflection structure, and thereby constructing a forming member for antireflection structure;

(4) a step of arranging the forming member such that the to-be-transferred material abuts on the surface where reflection of light should be prevented; and

(5) a step of fixing the to-be-transferred material to the surface where reflection of light should be prevented, and thereby forming an antireflection structure.

### EFFECT OF THE INVENTION

The forming member for antireflection structure according to the present invention comprises: a to-be-transferred material having the same shape as an antireflection structure; and a transfer material having a reversal shape of the antireflection structure. The transfer material can be peeled off from the to-be-transferred material. Thus, when the forming member for antireflection structure according to the present invention is employed, even in the inside of an assembled optical apparatus, for example, in a part having a complicated structure or a part to be held at the time of handling, the to-be-transferred material is solely bonded at an arbitrary predetermined position so that an antireflection structure is formed easily. Further, this does not affect the optical characteristics of the optical apparatus itself, and hence permits easy optical design.

Further, the transfer material according to the present invention employed in the forming member for antireflection structure can be used repeatedly, and hence improves the productivity for the antireflection structure.

Further, the optical apparatus according to the present invention employing the above-mentioned antireflection structure satisfactorily suppresses the entering of light whose reflection should be prevented, prevents generation of stray light that affects the image quality and the precision in photodetection, and reduces the reflection factor of unnecessary light in the inside of an optical apparatus. Thus, the optical apparatus according to the present invention is suitably employed, in particular, as an imaging optical apparatus having a member component such as a lens barrel and an aperture that holds an optical element arranged on the optical path. Further, in particular, when this optical apparatus is employed as an imaging optical apparatus, generation of ghost and flare is suppressed satisfactorily so that image quality formed from the imaging optical system is improved.

Further, the manufacturing method according to the present invention permits easy manufacturing of an optical apparatus having the above-mentioned excellent characteristics, and yet improves the productivity and reduces the cost.

### BRIEF DESCRIPTION OF THE DRAWINGS

FIG. 1 is a schematic diagram describing a method for forming an antireflection structure according to an embodiment.

FIG. 2A is a schematic perspective view showing a configuration of an antireflection structure having structural units of conical shape according to an embodiment.

FIG. 2B is a schematic perspective view showing a configuration of an antireflection structure having structural units of pyramid shape according to an embodiment.

FIG. 2C is a schematic perspective view showing a configuration of an antireflection structure having structural units of bell shape according to an embodiment.

FIG. 2D is a schematic perspective view showing a configuration of an antireflection structure having structural units of bell shape according to an embodiment.

FIG. 2E is a schematic perspective view showing a configuration of an antireflection structure having structural units of truncated conical shape according to an embodiment.

FIG. 2F is a schematic perspective view showing a configuration of an antireflection structure having structural units of truncated pyramid shape according to an embodiment.

FIG. 3 is a schematic diagram describing a method for forming an antireflection structure according to an embodiment.

FIG. 4 is a schematic plan view showing a configuration of a shutter unit serving as an example of an optical apparatus according to an embodiment.

FIG. 5 is a schematic plan view showing another configuration of a forming member for antireflection structure according to an embodiment.

### DESCRIPTION OF THE REFERENCE CHARACTERS

1 Transfer material
2, 2a Base substrate part
3 Recess part
4, 4a To-be-transferred material
5 Forming member
6 Surface where reflection of light should be prevented
7 Antireflection structure
8a to 8f Antireflection structure
9 Ultraviolet light
10 Mold-releasing agent layer
21 Shutter
22 Flexible board

### BEST MODE FOR CARRYING OUT THE INVENTION

### Embodiment

The following description is given for: a forming member for antireflection structure; a manufacturing method for the same; an optical apparatus employing an antireflection structure; and a manufacturing method for the same, according to an embodiment of the present invention.

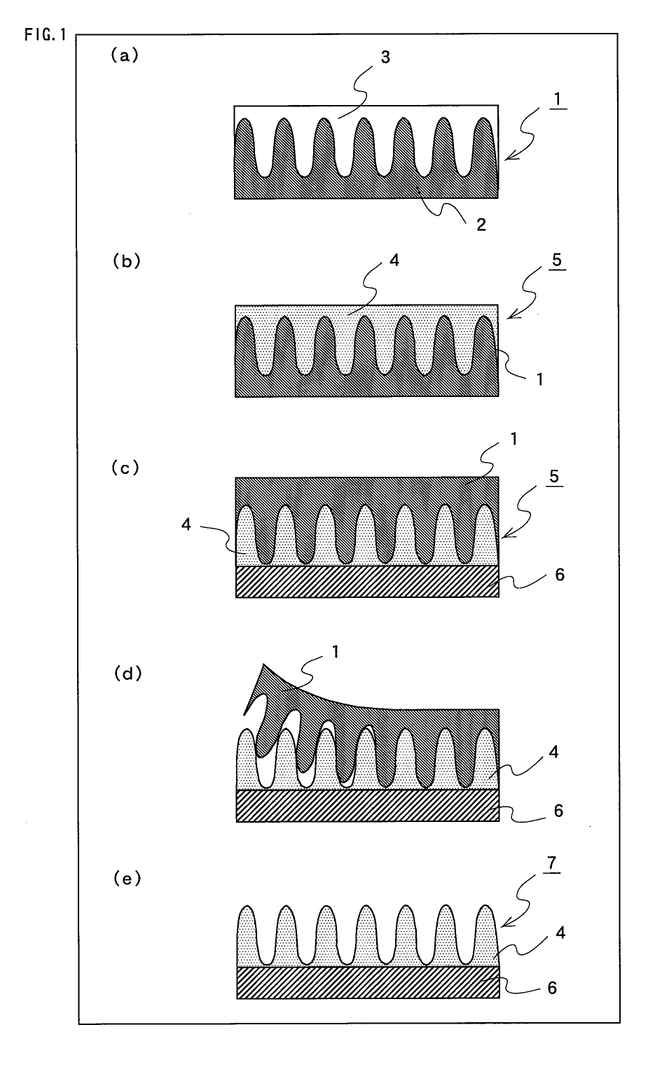

A forming member for antireflection structure comprises: a to-be-transferred material that is bonded at a predetermined position so as to form an antireflection structure; and a transfer material that accommodates the to-be-transferred material until the time of usage. FIG. 1 is a schematic diagram describing a method for forming an antireflection structure according to an embodiment.

FIG. 1(a) is a schematic sectional view showing a configuration of a transfer material 1. The transfer material 1 comprises: a base substrate part 2 composed of a material having flexibility; and a recess part (a structure having a reversal shape of an antireflection structure) 3 having a reversal shape of an antireflection structure formed on the principal surface of the base substrate part 2. Here, the antireflection structure indicates a structure in which structural units are arranged in the shape of an array at a period smaller than the minimum wavelength of light whose reflection should be prevented and which has an aspect ratio of unity or greater.

FIG. 1(b) shows a state that a to-be-transferred material 4 fills up the recess part 3 of the transfer material 1 so that a forming member for antireflection structure (referred to as a forming member, hereinafter) 5 is constructed. The to-be-transferred material 4 is a structure composed of a resin and having the same shape as the antireflection structure. The to-be-transferred material 4 may be formed by filling up the recess part 3 directly with the resin. Alternatively, the to-be-transferred material 4 may be formed in advance such as to have a reversal shape of an antireflection structure by using a die, and then filled into the recess part 3.

FIG. 1(c) shows a state that the forming member 5 is arranged on a surface 6 where reflection of light should be prevented at an arbitrary predetermined position in the inside of the optical apparatus. The forming member 5 is arranged such that the to-be-transferred material 4 abuts on the surface 6 where reflection of light should be prevented. The method for fixing the forming member 5 to the surface 6 where reflection of light should be prevented is not limited to particular ones. That is, an adhesive may be employed. Alternatively, a method may be employed that the to-be-transferred material 4 is melted and softened by heating, and then hardened.

FIG. 1(d) shows a state that the transfer material 1 is peeled off from the to-be-transferred material 4. Since the transfer material 1 is formed from a material having flexibility as described above, it can easily be peeled off without damage in the shape of the to-be-transferred material 4. As such, in this configuration, the to-be-transferred material 4 is peelable from the transfer material 1. Further, the transfer material 1 is easily collected without degradation in the shape, and hence can be used repeatedly and efficiently. Thus, the use of such a transfer material 1 permits mass production of the forming member 5, and hence reduces the cost.

FIG. 1(e) shows a state that the to-be-transferred material 4 is fixed onto the surface 6 where reflection of light should be prevented at an arbitrary predetermined position in the inside of the optical apparatus. As described above, the transfer material is peeled off so that the to-be-transferred material 4 is solely fixed onto the surface 6 where reflection of light should be prevented. As a result, an antireflection structure 7 is formed.

As described above, according to the present embodiment, the antireflection structure 7 can easily be formed even in a part where an antireflection structure has been difficult to be formed in the conventional art, for example, in the inside of an assembled optical apparatus, in particular, in a part having a complicated shape or a part to be held at the time of handling. Further, the antireflection structure 7 is composed solely of the to-be-transferred material 4, and hence does not affect the optical characteristics of the part where the antireflection structure 7 is provided. As such, in an optical apparatus employing the antireflection structure 7 composed of the to-be-transferred material 4, generation of unnecessary light such as stray light that affects the image quality and the precision in photodetection is prevented so that the reflection factor is reduced. Accordingly, an optical apparatus employing the antireflection structure 7 composed of the to-be-transferred material 4 is suitably employed, in particular, as an imaging optical apparatus having a member component such as a lens barrel and an aperture that holds an optical element arranged on the optical path. Further, in particular, when this optical apparatus is employed as an imaging optical apparatus, generation of ghost and flare is suppressed satisfactorily so that image quality formed from the imaging optical system is improved.

The present embodiment is described below in further detail. In the present embodiment, the base substrate part 2 constructing the transfer material 1 is not limited to particular materials, as long as the material has flexibility. For example, a metal, a resin or the like may be employed. When the base substrate part 2 is formed from a metal, the transfer material 1 has excellent durability, and hence can be used repeatedly. Further, when the base substrate part 2 is formed from a resin, it is preferable that the base substrate part 2 is a film or a sheet composed of a thermoplastic resin. In particular, among such materials, it is preferable that the base substrate part 2 is a film or a sheet composed of a light transmitting resin.

The method (the method for producing the transfer material 1) for forming the structure (the recess part 3) that has a reversal shape of an antireflection structure on the principal surface of the base substrate part 2 is not limited to particular ones. For example, the following methods may be employed.

For example, when the base substrate part 2 is formed from a metal, the following method may be adopted. A desired pattern is drawn on a substrate such as a quartz glass substrate by EB lithography or the like. Then, treatment processing such as dry etching is performed on the substrate, so that a precision master mold is formed that has been precision-processed in advance into the same shape as an antireflection structure. After that, press molding is performed onto the principal surface of the base substrate part 2 by using the obtained master mold. As a result, a recess part 3 having a reversal shape of a desired antireflection structure is formed on the principal surface of the base substrate part 2, so that a transfer material 1 is obtained.

Further, for example, when the base substrate part 2 is formed from a resin, in particular, from a thermoplastic resin, the following method is also effective. First, a molding die having the same shape as a desired antireflection structure is produced by using a metal such as aluminum or brass and by an appropriate combination of etching, X-ray lithography, photolithography and the like. Then, the molding die is heated up, and then thermal press processing is performed on the principal surface of the base substrate part 2. As a result, a recess part 3 having a reversal shape of a desired antireflection structure is formed on the principal surface of the base substrate part 2, so that a transfer material 1 is obtained.

Here, in each method described above, a die, a mold or the like formed by electroforming processing may be employed as the master mold or the molding die.

Further, when the base substrate part 2 is formed from a resin, a recess part 3 having a reversal shape of an antireflection structure may be formed by X-ray lithography directly on the principal surface of the base substrate part 2.

Employable resins for forming the base substrate part 2 include: thermoplastic resins such as an acrylic resin such as polymethyl methacrylate (referred to as PMMA, hereinafter), a styrene resin such as polystyrene, crystalline polystyrene (referred to as SPS, hereinafter) or ABS resin, a polyolefin such as polypropylene or polyethylene, polyacetal, polyamide, polycarbonate (referred to as PC, hereinafter), polyethylene terephthalate (referred to as PET, hereinafter), polyphenylene sulfide (referred to as PPS, hereinafter), polysulfone, polyether, polyether sulphone, an urethane elastomer, a polyamide elastomer, a styrene elastomer, and polyvinyl chloride; and thermosetting resins such as a silicone resin and an epoxy resin. Among these, PMMA and PC are preferable in particular. Further, among the thermoplastic resins, alight transmitting resin is more preferable. Here, the light transmitting resin indicates a resin having light transmissive property in a particular wavelength range. An example of the particular wavelength range is a wavelength range (150 to 400 nm) of ultraviolet light.

The thickness of the base substrate part 2 is not limited to particular values. For example, when the shape of the base substrate part 2 is to be changed flexibly in order that the base substrate part 2 should be in close contact with a component having a complicated shape like a member component such as a lens barrel and an aperture for holding an optical element arranged on the optical path, a preferable thickness is approximately 5 μm to 1 mm. Further, a more preferable thickness is approximately 20 to 300 μm.

Further, when the transfer material 1 is formed, among the light transmitting resins, from a resin that can be decomposed by irradiation of light such as ultraviolet light, the transfer material 1 is rapidly decomposed merely by irradiation of light, and then the decomposed substance can be treated as fine waste particulates. Thus, in this case, an advantage is obtained that the peel off of the transfer material 1 in the process shown in FIG. 1(d) becomes unnecessary. Further, as described later, for example, when the to-be-transferred material 4 is composed of a light curing resin, decomposition of the transfer material 1 may be achieved by the irradiation of light at the time of curing of the light curing resin. Here, the irradiation of light is not limited to irradiation of ultraviolet light. In addition to this, irradiation of electron beams or the like is also included.

Here, in the present embodiment, the transfer material 1 having the above-mentioned configuration may be used alone by itself. That is, the transfer material 1 may be used repeatedly as a die for forming the to-be-transferred material 4. In particular, such a transfer material 1 that the base substrate part 2 is formed from a metal has excellent durability and hence is preferable.

In the present embodiment, the resin used for forming the to-be-transferred material 4 is not limited to particular ones. However, curing resins and anaerobic resins that cure in particular gases can be used preferably. Among these, a light curing resin is preferable in particular.

Employable resins for forming the to-be-transferred material 4 include: thermoplastic resins such as an acrylic resin such as PMMA, a styrene resin such as polystyrene, SPS or ABS resin, a polyolefin such as polypropylene or polyethylene, polyacetal, polyamide, PC, PET, PPS, polysulfone, polyether, polyether sulphone, an urethane elastomer, a polyamide elastomer, a styrene elastomer, and polyvinyl chloride; and thermosetting resins such as a silicone resin and an epoxy resin. Among these, PMMA and PC are preferable in particular. Further, among the thermoplastic resins, a light curing resin is more preferable. As the light curing resin, an ultraviolet curing resin is preferable that cures in a particular wavelength range where the light transmitting resin for forming the base substrate part 2 has transmissive property, for example, in a wavelength range (150 to 400 nm) of ultraviolet light. The ultraviolet curing resin is easy to handle and inexpensive, and can stably form the to-be-transferred material 4. However, the present invention is not limited to such an ultraviolet curing resin, and another resin may be employed that cures in another wavelength range. When an ultraviolet curing resin is employed as a light curing resin, an acrylic ultraviolet curing resin is preferable in the point that light transmissive property of the resin is not too high and that the resin has mold-releasing property.

Further, when high light shielding property and light absorbing property are requested in the antireflection structure 7, the to-be-transferred material 4 is preferable to be formed from a black material colored in black, for example, with a dye or a pigment. The antireflection structure 7 composed of the to-be-transferred material 4 formed from a black material can absorb unnecessary light, and hence satisfactorily suppresses generation of unnecessary light itself so as to suppress generation of stray light to an improved extent. A suitably employable black material is, for example, a material obtained by mixing a black dye containing a pigment such as cyan, magenta and yellow or alternatively a black pigment such as carbon black into a resin such as a thermoplastic resin.

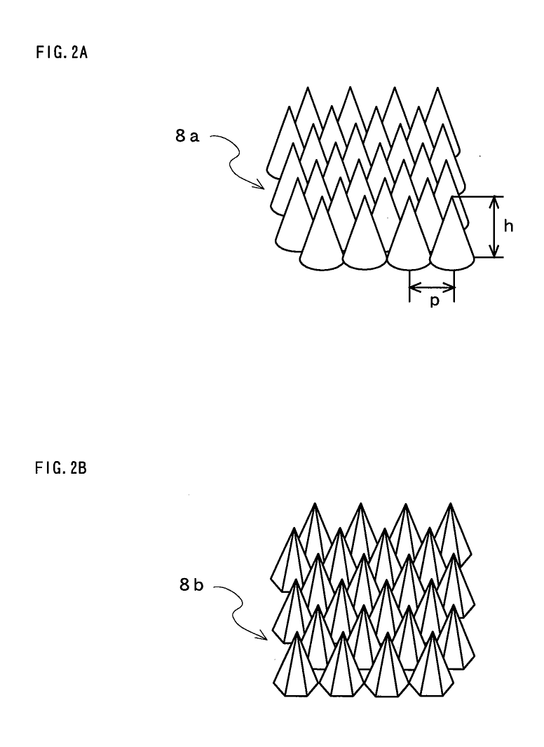

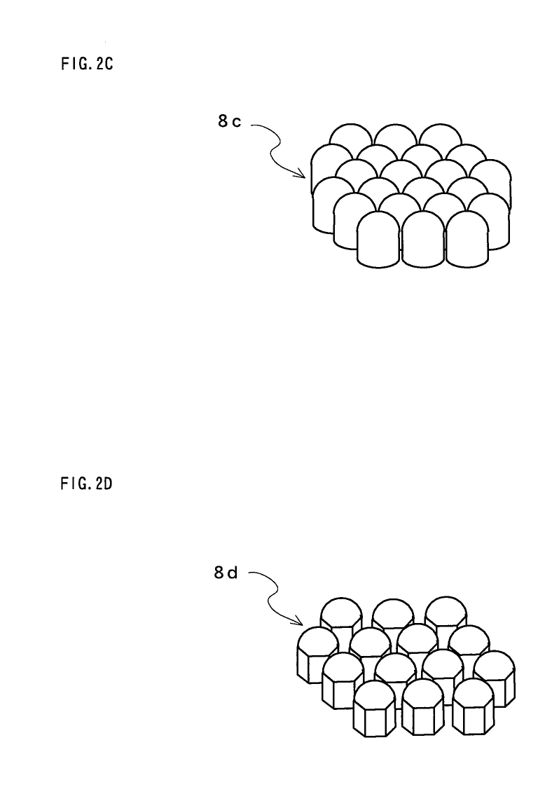

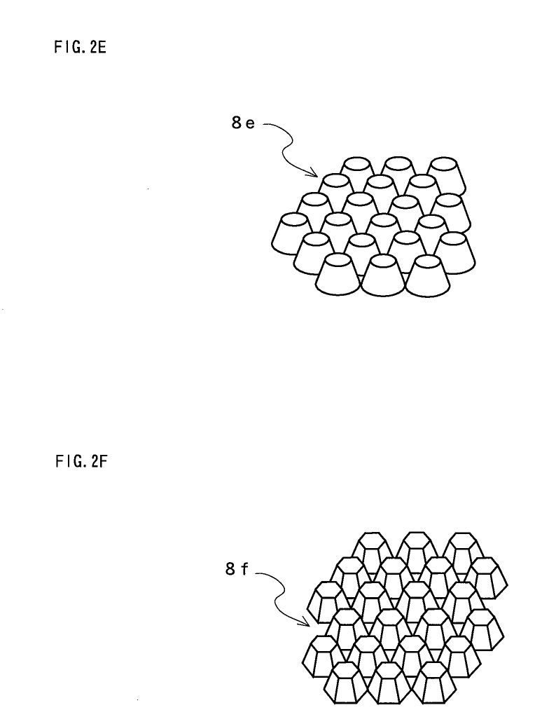

The antireflection structure according to the present embodiment indicates a structure in which structural units are arranged in the shape of an array at a period (e.g., indicated by p in the following FIG. 2A) smaller than the minimum wavelength of light whose reflection should be prevented and in which the aspect ratio defined as the ratio between the period and the height (e.g., indicated by h in the following FIG. 2A) of the structural unit is unity or greater. When such an antireflection structure is formed on at least one of the surfaces where reflection of light should be prevented in the inside of an optical apparatus, reflection of light is prevented on the surface where reflection of light should be prevented so that generation of ghost and flare by stray light can be suppressed. Here, in the present embodiment, the aspect ratio of the antireflection structure is preferable to be 2 or greater, and more preferable to be 3 or greater. An antireflection structure having such an aspect ratio expresses further improved antireflection effect.

When the antireflection structure is a structure in which a large number of structural units are arranged in two dimensions, the above-mentioned period indicates the period in the direction where the arrangement has the highest density.

Further, obviously, the antireflection structure indicates a structure for preventing the reflection of unnecessary light which should be prevented from being reflected. However, in addition to a mode that reflection of light whose reflection should be prevented is prevented completely, the present embodiment includes a mode that reflection of light whose reflection should be prevented is reduced to an extent that generation of ghost and flare by stray light is satisfactorily suppressed.

Examples of such an antireflection structure are: a structure in which structural units are arranged in a rounded sinusoidal shape as shown in FIG. 1; an antireflection structure 6a having structural units of conical shape as shown in FIG. 2A; an antireflection structure 6b having structural units of pyramid shape as shown in FIG. 2B; antireflection structures 6c and 6d having structural units of bell shape as shown in FIG. 2C and FIG. 2D; an antireflection structure 6e having structural units of truncated conical shape in which the tip part is flattened as shown in FIG. 2E; and an antireflection structure 6f having structural units of truncated pyramid shape in which the tip part is flattened as shown in FIG. 2F. Among these, from the point that a remarkably excellent antireflection effect is obtained, an antireflection structure is preferable that has structural units of tapered shape such as conical shape and pyramid shape. Here, each structural unit need not have an exact geometrical shape like: a tapered shape such as a conical shape and a pyramid shape; a bell shape; and a truncated tapered shape such as a truncated conical shape and a truncated pyramid shape. That is, the shape may be a substantially tapered shape, a substantially bell shape, a substantially truncated tapered shape or the like.

Further, FIGS. 2A to 2F show antireflection structures having structural units of protruding shape. However, the present embodiment is not limited to an antireflection structure having structural units of such protruding shape. For example, an antireflection structure may be employed in which structural units of recess shape such as tapered shape, bell shape and truncated tapered shape are arranged in plane in the shape of an array at a period smaller than the minimum wavelength of light whose reflection should be prevented. Further, structural units of protruding shape and structural units of recess shape may be employed simultaneously in a single antireflection structure. Here, in the case of an antireflection structure in which structural units of protruding shape and structural units of recess shape are employed simultaneously, the sum of the height of the protrusion and the depth of the recess is referred to as the height of the structural unit.

Here, in addition to visible light (wavelength range: 400 to 700 nm), the above-mentioned light whose reflection should be prevented may be, for example, ultraviolet light (wavelength range: 150 to 400 nm), near-infrared light (wavelength range: 700 nm to 2 μm) or far-infrared light (wavelength range: 2 to 13 μm). In the present embodiment, the optical apparatus indicates an apparatus that has, in the inside, at least one surface where reflection of light should be prevented. An example of this is an imaging optical apparatus. When the optical apparatus is an imaging optical apparatus, it is preferable that the surface where reflection of light should be prevented is included in at least one selected from, for example: a lens barrel used in a projection lens system, an imaging optical system or the like; a light-shielding member for blocking at least a part of light beams; an aperture diaphragm for adjusting the F-number serving as the index of luminosity of an optical system; a flare-cutting diaphragm for cutting flare of off-axis light beams in an imaging optical system; a stray light-preventing member for preventing stray light in an imaging optical system; and a lens-holding member attached to a lens so as to hold the lens.

In the present embodiment, when the forming member having the above-mentioned configuration is employed, an antireflection structure can easily be formed even in a part where an antireflection structure has been difficult to be formed in the conventional art, for example, in the inside of an assembled optical apparatus, in particular, in a lens barrel having a complicated shape and a flexible board which need be held at the time of handling, without affecting the optical characteristics of the optical apparatus itself. By virtue of this, for example, in an imaging optical system, the influence of internal reflected light from the lens barrel that reaches the imaging surface and of reflected light from the flexible board can be reduced. Further, since the antireflection structure has a comparatively thin configuration, the reflection factor can be reduced without greatly affecting the optical characteristics of the optical component such as a lens element. Furthermore, since a high antireflection effect is obtained in the inside of the optical apparatus, even when the optical apparatus is an imaging optical apparatus of reduced size or the like, generation of stray light is prevented, and generation of ghost and flare is satisfactorily suppressed so that image characteristics is improved.

Detailed examples according to the present embodiment are described below. These detailed examples are described for the case that the transfer material is formed from a light transmitting resin having light transmissive property in a particular wavelength range and that the to-be-transferred material is formed from a light curing resin curing with light having a wavelength range including the particular wavelength range. The particular wavelength range is a wavelength range (150 to 400 nm) of ultraviolet light, while the light curing resin is an ultraviolet curing resin.

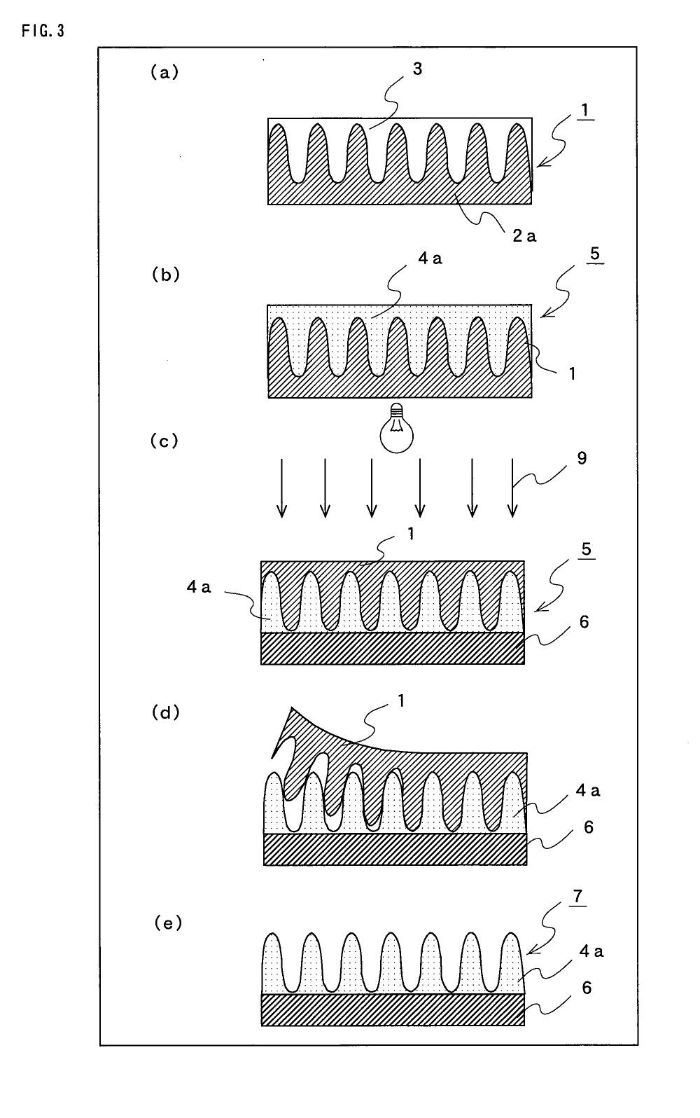

FIG. 3 is a schematic diagram describing a method for forming an antireflection structure according to an embodiment.

FIG. 3(a) is a schematic sectional view showing a configuration of a transfer material 1. The transfer material 1 comprises: a base substrate part 2a formed from a light transmitting resin having flexibility; and a recess part (a structure having a reversal shape of an antireflection structure) 3 having a reversal shape of an antireflection structure formed on the principal surface of the base substrate part 2a. The transfer material 1 was produced by the following procedure. For the base substrate part 2a, an acrylic resin sheet was used that had a width of approximately 10 mm, a length of approximately 50 mm and a thickness of approximately 0.2 mm and had ultraviolet transmissive property. As for the selection of the size of the acrylic resin sheet, the width of this order was selected from the point of comparatively easy handling. The length of this order was selected from the point that, for example, when the surface where reflection of light should be prevented in an optical apparatus is contained in the lens barrel, the inner periphery of the lens barrel is approximately 50 mm. Further, the thickness of this order was selected from the point that this value falls within a range where flexibility is maintained and that a much greater thickness causes difficulty in bending. However, the size and the shape of the base substrate part 2a are not limited to particular ones. Thus, it is preferable to change them appropriately in accordance with the desired application of the transfer material 1. A die in which an antireflection structure was formed in advance was pressed against the principal surface of the acrylic resin sheet, so that a recess part 3 was formed in which structural units having a rounded sinusoidal shape and a height of 200 to 250 nm are arranged in the shape of an array at a period of 300 nm and which had a reversal shape of an antireflection structure. When incident light (light whose reflection should be prevented) is visible light, this recess part 3 corresponds to an antireflection structure in which structural units are arranged in the shape of an array at a period smaller than the wavelength range (400 to 700 nm) of the visible light and in which the aspect ratio defined as the ratio between the period and the height of the structural unit is unity or greater. FIG. 3(b) shows a state that the to-be-transferred material 4a composed of the ultraviolet curing resin fills up the recess part 3 of the transfer material 1. When the ultraviolet curing resin was filled directly into the recess part 3, the surface of the to-be-transferred material 4a became an almost smooth plane. Here, in a case that ultraviolet curing resin has a low viscosity and hence is expected to flow out from the recess part 3, ultraviolet light may be irradiated for the purpose of tentative curing of the ultraviolet curing resin before the next process so that the flow-out from the recess part 3 may be prevented.

FIG. 3(c) shows a state that the forming member 5 is arranged on a surface 6 where reflection of light should be prevented at an arbitrary predetermined position in the inside of the optical apparatus. The forming member 5 is arranged such that the to-be-transferred material 4a abuts on the surface 6 where reflection of light should be prevented. In the present embodiment, light having a wavelength range where the ultraviolet curing resin cures, that is, ultraviolet light 9, is irradiated from the transfer material 1 side onto the forming member 5 arranged as described above. The ultraviolet light 9 is irradiated through the transfer material 1 onto the ultraviolet curing resin. As a result, the ultraviolet curing resin cures so that the to-be-transferred material 4a is fixed onto the surface 6 where reflection of light should be prevented in the optical apparatus.

FIG. 3(d) shows a state that the transfer material 1 is peeled off from the to-be-transferred material 4a. Since the transfer material 1 is formed from a material having flexibility as described above, it can be peeled off without damage in the shape of the to-be-transferred material 4a. As such, in this configuration, the to-be-transferred material 4a is peelable from the transfer material 1. Further, the transfer material 1 is collected without degradation in the shape, and hence can be used repeatedly and efficiently. Thus, the use of such a transfer material 1 permits mass production of the forming member 5, and hence reduces the cost.

FIG. 3(e) shows a state that the to-be-transferred material 4a is fixed onto the surface 6 where reflection of light should be prevented at an arbitrary predetermined position in the inside of the optical apparatus. As described above, the transfer material is peeled off so that the to-be-transferred material 4a is solely fixed onto the surface 6 where reflection of light should be prevented. As a result, an antireflection structure 7 is formed.

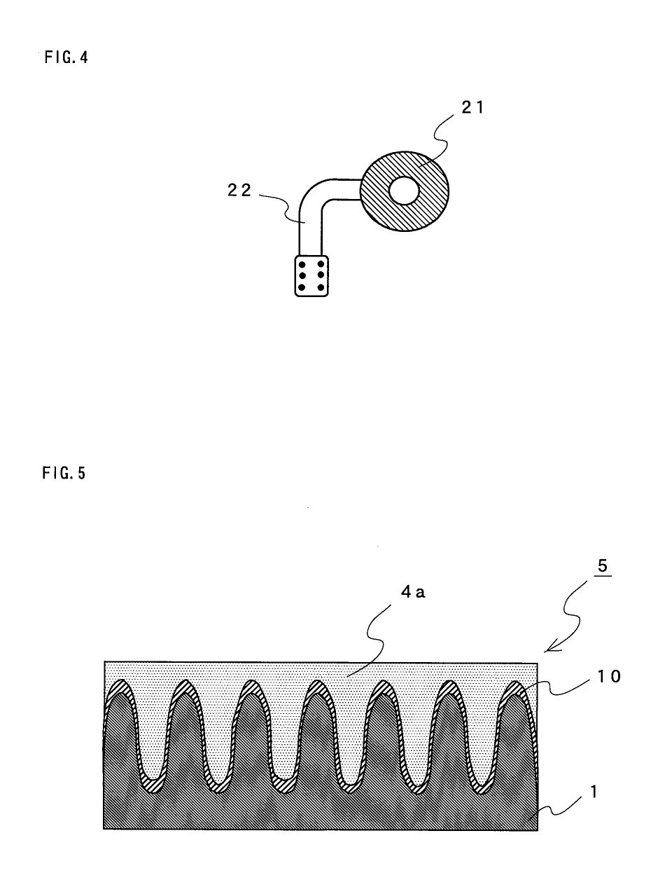

Here, an example of the surface where reflection of light should be prevented at an arbitrary predetermined position in the inside of the optical apparatus is shown in a drawing. FIG. 4 is a schematic plan view showing a configuration of a shutter unit serving as an example of an optical apparatus according to an embodiment. In FIG. 4, a shutter 21 of disc shape is connected to a flexible board 22 in which an antireflection structure is formed on its surface. As such, according to the above-mentioned method, even in a shutter unit in an assembled state, an antireflection structure was easily formed on the flexible board 22.

Further, in addition to the shutter unit shown in FIG. 4, forming members were bonded to an aperture diaphragm and a lens-holding member in the inside of the imaging optical apparatus. Then, ultraviolet light was irradiated so that an antireflection structure was formed. As a result, unnecessary light was efficiently absorbed by the antireflection structure, so that an imaging optical apparatus was realized that is free from notable image degradation such as ghost and flare and that has satisfactory contrast.

Further, FIG. 5 is a schematic plan view showing another configuration of a forming member for antireflection structure according to an embodiment. In the present embodiment, when the transfer material 1 is formed from a light transmitting resin and the to-be-transferred material 4a is formed from a light curing resin, it is preferable that a mold-releasing agent layer 10 formed from a mold-releasing agent is provided between the transfer material 1 and the to-be-transferred material 4a as shown in FIG. 5. A suitably employable mold-releasing agent is a silicone mold-releasing agent. Further, the mold-releasing agent layer 10 is preferable to be formed in an almost uniform thickness in the range of 20 to 50 nm. As such, when the mold-releasing agent layer 10 formed from a mold-releasing agent is provided between the transfer material 1 and the to-be-transferred material 4a, the transfer material 1 can more easily be peeled off from the to-be-transferred material 4a in the process shown in FIG. 3(d). As such, the transfer material 1 is remarkably easily collected without damage in its shape, and hence is repeatedly used more efficiently. Thus, the use of such a transfer material 1 permits easy mass production of the forming member 5, and hence reduces the cost further.

Further, in a case that the mold-releasing agent layer 10 is provided, an antireflection structure 7 having a more excellent antireflection effect is obtained when the tip shape of the recess part 3 of the transfer material 1 is made thin with taking into consideration the shape of the antireflection structure 7 formed from the to-be-transferred material 4a and the thickness of the mold-releasing agent layer 10.

Further, when the transfer material 1 is formed, among the light transmitting resins, from a resin that can be decomposed by irradiation of light such as ultraviolet light, the transfer material 1 is rapidly decomposed merely by irradiation of the light for curing the to-be-transferred material 4a shown in FIG. 3(c). Then, the decomposed substance can be treated as fine waste particulates. Thus, in this case, an advantage is obtained that the peel off of the transfer material 1 in the process shown in FIG. 3(d) becomes unnecessary. Here, the irradiation of light is not limited to irradiation of ultraviolet light. In addition to this, irradiation of electron beams or the like is also included.

Here, the process shown in FIG. 3(c) has been described for the case that ultraviolet light 9 is irradiated from the transfer material 1 side so that the to-be-transferred material 4a is cured. However, the present embodiment is not limited to this case. That is, in a case that light of a wavelength range where the ultraviolet curing resin cures, that is, ultraviolet light, can transmit through the surface 6 where reflection of light should be prevented at an arbitrary predetermined position in the inside of the optical apparatus, ultraviolet light may be irradiated from the surface 6 side where reflection of light should be prevented, so that the to-be-transferred material 4a may be cured. Further, the curing of the to-be-transferred material 4a is not limited to this method of irradiation of ultraviolet light. That is, any method may be employed that can impart energy capable of curing the to-be-transferred material 4a. Such examples are: a method of irradiation of light other than ultraviolet light, like visible light; and a method of heating up.

### INDUSTRIAL APPLICABILITY

The forming member for antireflection structure according to the present invention is widely applicable to a part containing a surface where reflection of light should be prevented, for example, in the inside of an optical apparatus such as a digital camera and a printer.

1-11. (canceled)

12. A manufacturing method for optical apparatus in which an antireflection structure is provided on at least one of surfaces, at predetermined positions in the inside, where reflection of light should be prevented, the manufacturing method comprising:
(1) a step of forming, on a principal surface of a base substrate part having flexibility, a structure having a reversal shape of an antireflection structure in which structural units are arranged in a shape of an array at a period smaller than a minimum wavelength of light whose reflection should be prevented and which has an aspect ratio of unity or greater, and thereby producing a transfer material;
(2) a step of forming from a resin a to-be-transferred material serving as a structure having the same shape as the antireflection structure;
(3) a step of arranging the transfer material and the to-be-transferred material such that the structure having the same shape as the antireflection structure fills up the structure having a reversal shape of the antireflection structure, and thereby constructing a forming member for antireflection structure;
(4) a step of arranging the forming member such that the to-be-transferred material abuts on the surface where reflection of light should be prevented; and
(5) a step of fixing the to-be-transferred material to the surface where reflection of light should be prevented, and thereby forming an antireflection structure.

13. The manufacturing method as claimed in claim 12, comprising a step of, after arranging the forming member such that the to-be-transferred material abuts on the surface where reflection of light should be prevented, peeling off the transfer material from the to-be-transferred material.

14. The manufacturing method as claimed in claim 12, wherein the transfer material is composed of a light transmitting resin, and the to-be-transferred material is composed of a light curing resin.

15. The manufacturing method as claimed in claim 14, wherein light having a wavelength range where the to-be-transferred material cures is irradiated onto the to-be-transferred material through the transfer material so that the to-be-transferred material is cured and fixed onto the surface where reflection of light should be prevented.

16. The manufacturing method as claimed in claim 15, wherein the light transmitting resin is a resin that can be decomposed by irradiation of light, and is decomposed by the irradiation of light at the time of curing of the to-be-transferred material.
